(19) United States
(12) Patent Application Publication
(10) Pub. No.: US 2012/0001822 A1
(43) Pub. Date: Jan. 5, 2012

(54) WIRELESS COMMUNICATION APPARATUS

(75) Inventors: Zhao LIU, Kawasaki (JP); Masaru KANAZAWA, Kawasaki (JP); Masatomo MORI, Kawasaki (JP)

(73) Assignee: FUJITSU LIMITED, Kawasaki-shi (JP)

(21) Appl. No.: 13/166,906

(22) Filed: Jun. 23, 2011

(30) Foreign Application Priority Data
Jun. 30, 2010 (JP) 2010-150530

(51) Int. Cl. H01Q 1/50; H01Q 3/24

(52) U.S. Cl. 343/852; 343/876

(57) ABSTRACT

A wireless communication apparatus includes a first housing, a second housing which is openably and closably connected to the first housing through a hinge, a first conductor part which is arranged on the first housing, a second conductor and an antenna element, which are arranged on the second housing and an antenna switching part that makes the first conductor part, the second conductor part, and the antenna element serve as a dipole antenna when the first housing and the second housing are in an open state, and makes the antenna element serve as a monopole antenna when the first conductor and the second conductor are in a closed state.

### CROSS-REFERENCE TO RELATED APPLICATIONS

This application is based upon and claims the benefit of priority of the prior Japanese Patent Application No. 2010-150530, filed on Jun. 30, 2010, the entire contents of which are incorporated herein by reference.

### FIELD

The present invention relates to an antenna switching control using a plurality of antenna elements.

### BACKGROUND

Arrangement of antenna elements in the respective foldable housing parts of a portable apparatus, such as a mobile terminal, has been known in the art.

For example, Japanese Laid-open Patent Publication No. 2004-229048 discloses that a dipole antenna is constructed of a first antenna element in one housing part and a conductive antenna in the other housing part; and a monopole antenna is constructed of a second antenna element located near a hinge.

Japanese Laid-open Patent Publication No. 2006-14128 discloses that one of openable/closable housing parts is provided with first and second conductive plates. The conductive plates are controlled between open-state and connected-state each other in response to the opening and closing of the housing parts.

### SUMMARY

According to an aspect of the embodiment, a wireless communication apparatus includes a first housing, a second housing which is openably and closably connected to the first housing through a hinge, a first conductor part which is arranged on the first housing, a second conductor and an antenna element, which are arranged on the second housing and an antenna switching part that makes the first conductor part, the second conductor part, and the antenna element serve as a dipole antenna when the first housing and the second housing are in an open state, and makes the antenna element serve as a monopole antenna when the first conductor and the second conductor are in a closed state.

The object and advantages of the invention will be realized and attained by at least the elements, features, and combinations particularly pointed out in the claims.

It is to be understood that both the foregoing general description and the following detailed description are example and explanatory and are not restrictive of the invention, as claimed.

### BRIEF DESCRIPTION OF DRAWINGS

FIG. 1 is a diagram each illustrating an example dipole antenna which is set up when a portable apparatus according to a first embodiment is in an open state;

FIG. 2 is a diagram illustrating an example configuration of a monopole antenna which is set up when the portable apparatus is in a closed state;

FIG. 3 is a diagram illustrating an example configuration of a cell phone in an open state according to a second embodiment;

FIG. 4 is a diagram illustrating an example wired power supply line passing through a hinge of the cell phone;

FIG. 5 is a diagram illustrating an example dipole antenna which is set up when the cell phone is in an open state;

FIG. 6 is a diagram illustrating an example configuration of a monopole antenna which is set up when the cell phone is in a closed state;

FIG. 7 is a diagram illustrating an example antenna-switching circuit when the cell phone is in an open state;

FIG. 8 is a diagram illustrating an example antenna-switching circuit when the cell phone is in a closed state;

FIG. 9 is a diagram illustrating an example control logic table of a changeover switch part;

FIG. 10 is a circuit diagram illustrating an example antenna-switching circuit and an example matching circuit;

FIG. 11 is a diagram illustrating an example connection structure of a flexible substrate passing through the hinge;

FIG. 12 is a diagram illustrating an example connection structure of a flexible substrate passing through the hinge;

FIG. 13 is a diagram illustrating an example connection structure of a flexible substrate passing through the hinge;

FIG. 14 is a diagram illustrating an example connection structure of a flexible substrate passing through the hinge;

FIG. 15 is a diagram illustrating the radiation characteristics of a dipole antenna when the cell phone is in a closed state;

FIG. 16 is a diagram illustrating the radiation characteristics of a monopole antenna when the cell phone is in a closed state;

FIG. 17 is a diagram illustrating an example configuration of an antenna when a cell phone according to a third embodiment is in an open state;

FIG. 18 is a diagram illustrating an example dipole antenna which is set up when the cell phone is in an open state;

FIG. 19 is a diagram illustrating an example configuration of a monopole antenna which is set up when the cell phone is in a closed state;

FIG. 20 is a diagram illustrating an example antenna-switching circuit when the cell phone is in an open state;

FIG. 21 is a diagram illustrating an example antenna-switching circuit when the cell phone is in a closed state;

FIG. 22 is an example configuration of a TV receiver circuit according to a fourth embodiment;

FIG. 23 is a diagram illustrating an example configuration of a dipole antenna which is set up when a cell phone is in an open state;

FIG. 24 is a diagram illustrating an example configuration of a monopole antenna which is set up when the cell phone is in a closed state;

FIG. 25 is a diagram illustrating a comparative example of an antenna which is set up when a cell phone is in an open state; and

FIG. 26 is a diagram illustrating a comparative example of an antenna which is set up when a cell phone is in a closed state.

### DESCRIPTION OF EMBODIMENTS

In the case where antenna elements are installed on respective foldable housing parts and these antenna elements are operated in different configurations depending on the open/closed state of the housing parts, the antenna performance may degrade when usable frequencies are in a lower frequency band. In particular, if a reduction in size of the apparatus is desired, the performance of the apparatus may degrade due to a decrease in antenna length (electric length) with respect to the wavelength used. Furthermore, the installation of an extension board in the housing to make the antenna length longer may involve an increase in space in the housing and may lead to disadvantages in reducing the size and thickness of the apparatus.

### First Embodiment

According to a first embodiment, a portable apparatus is designed to set up a dipole antenna when a housing is opened and to set up a monopole antenna when the housing is closed.

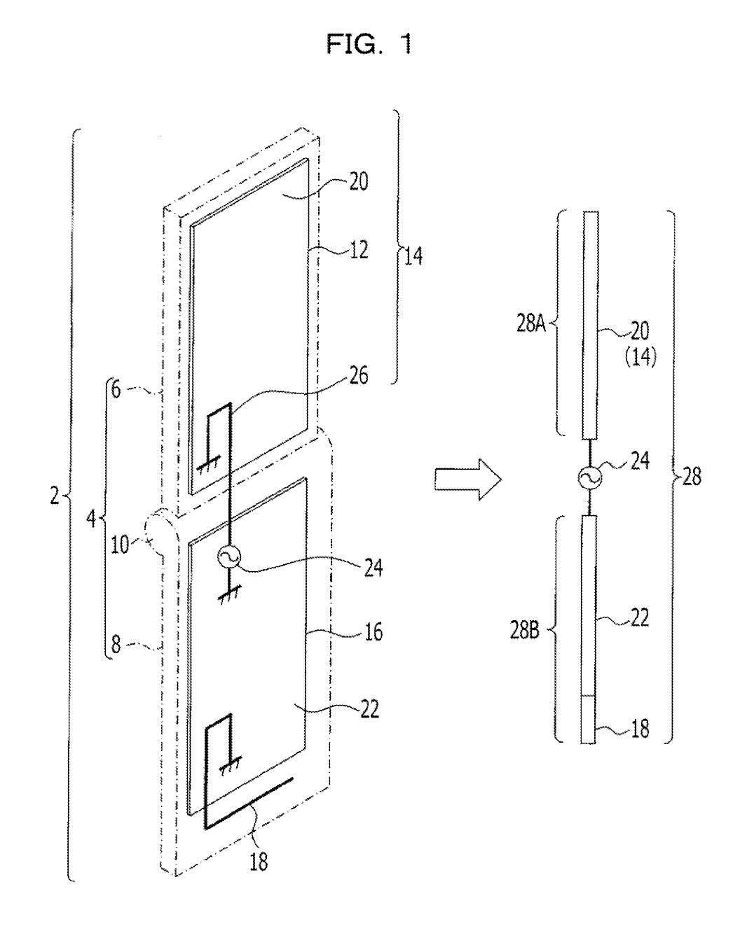

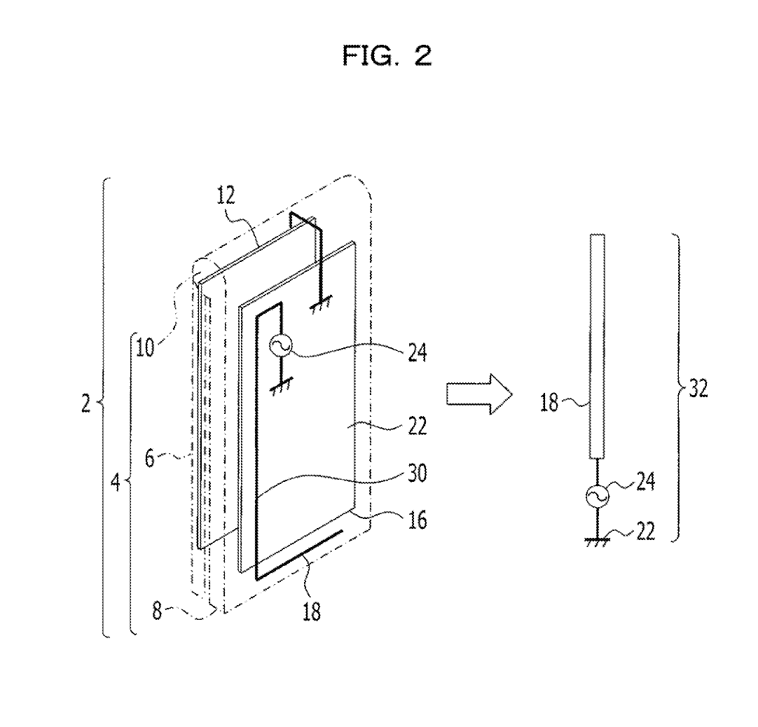

The first embodiment will be described with reference to FIG. 1 and FIG. 2. FIG. 1 illustrates an example dipole antenna which is set up when a portable apparatus is in an open state. FIG. 2 illustrates an example monopole antenna which is set up when a portable apparatus is in a closed state.

This portable apparatus 2 is an example portable apparatus of the present disclosure and includes a foldable housing 4. As illustrated in FIG. 1 and FIG. 2, this housing 4 includes a first housing part 6 and a second housing part 8, which are able to perform an open or close movement about a hinge 10.

The housing part 6 has a first circuit board 12 and functions as a first antenna element 14.

The housing part 8 is provided with a second circuit board 16, and a second antenna element 18 is arranged on the exterior of the second circuit board 16. The circuit board 12 is provided with a ground conductor 20 and the circuit board 16 is provided with a ground conductor 22. The ground conductors 20 and 22 are example conductor parts.

The housing part 8 is provided with a power supply point 24 as a power supply part. The power supply point 24 is connected to the ground conductor 20 of the circuit board 12 through a power supply line 26 and also connected to the ground conductor 22 of the circuit board 16.

When the housing 4 is in an open state, as illustrated in FIG. 1, one antenna element part 28A of a dipole antenna 28 serves as a first antenna element 14 and another antenna element part 28B serves as a ground conductor 22 of an antenna element 18. In this case, the antenna element 18 connected to the ground conductor 22 serves as an extension element of the ground conductor 22.

If the housing 4 is in a closed state, as illustrated in FIG. 2, the antenna element 18 is connected to the power supply point 24 through a power supply line 30, thereby forming a monopole antenna 32. In this case, the ground conductor 22 of the circuit board 16 is connected to the ground conductor 20 of the circuit board 12 because the power supply line 26 is replaced by the power supply line 30.

This configuration causes the housing 4 in open state to form a dipole antenna 28. In this case, one antenna element part 28B connects the antenna element 18 to the ground conductor 22. Thus, the antenna length of the ground conductor 22 is extended by the antenna element 18. As a result, the antenna characteristics of the dipole antenna 28 degradation may be reduced or prevented because enhanced antenna characteristics of the dipole antenna 28, a reduction of size and thickness of the housing 4, and lower usable frequency may be attained.

Furthermore, when the housing 4 is in a closed state, the antenna element 18 forms a monopole antenna 32. In this case, the antenna element 18 obtains monopole antenna characteristics without receiving any influence from the cancellation of emission current passing through the opposite ground conductors 20 and 22.

Therefore, the dipole antenna 28 is formed in the open state and the monopole antenna 32 is formed in the closed state, so that broadcasting, such as digital broadcasting, may be efficiently received using any of these antennas.

### Second Embodiment

According to a second embodiment, a portable apparatus is designed to detect the open or closed state of a housing and automatically switch between a dipole antenna and a monopole antenna in response to the result of the detection.

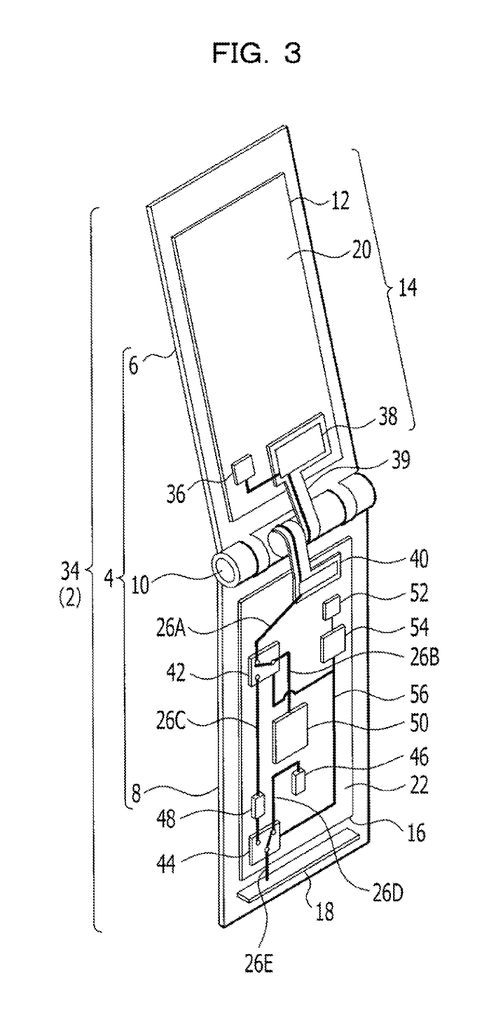

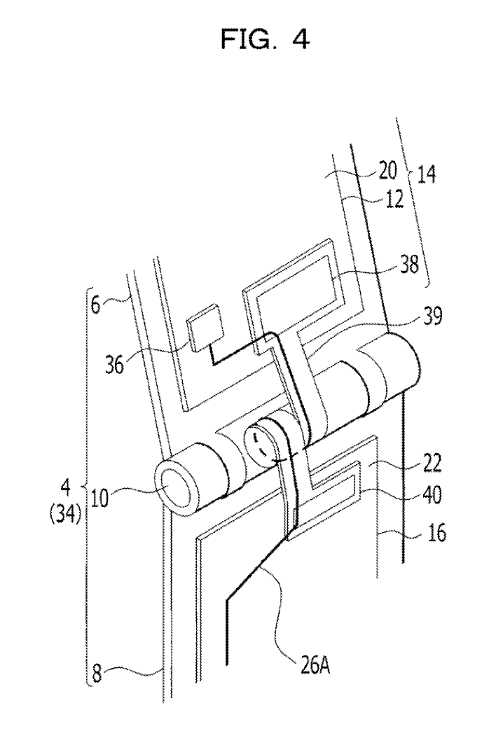

The second embodiment will be described with reference to FIG. 3 and FIG. 4. FIG. 3 is a diagram illustrating an example configuration of a portable apparatus in an open state according to a second embodiment. FIG. 4 is a diagram illustrating an example wired power supply line passing through a hinge of the portable apparatus. In FIGS. 3 and 4, the same reference numerals denote substantially the same structural components as those illustrated in FIG. 1 and FIG. 2.

A cell phone 34 is an example portable apparatus of the present disclosure. As illustrated in FIG. 3, a housing 4 is divided into a housing part 6 and a housing part 8, which are connected to each other by a hinge 10 to allow them to be opened and closed and to be foldable as described above. The hinge 10 includes a hinge mechanism that connects the housing parts 6 and 8 so as to be rotatable about the hinge axis.

The housing part 6 is a display-side housing on which a circuit board 12 is mounted. A ground conductor (GND) 20, a first matching circuit 36, and a connector 38 are mounted on the circuit board 12. The ground conductor 20 forms an antenna element 14 which has been described above. The connector 38 is connected to the ground conductor 20 through the matching circuit 36.

The housing part 8 is, for example, an operation-side housing on which a circuit board 16 and an antenna element 18 are mounted. A flexible substrate (cable) 39 and a power supply line 26A are arranged between the housing part 6 and the housing part 8. The circuit board 16 includes a ground conductor (GND) 22, power supply lines 26B, 26C, 26D, and 26E, a connector 40, changeover switches 42 and 44, matching circuits 46 and 48, a wireless unit 50, an open/close sensor 52, and a central processing unit (CPU) 54. The matching circuit 46 corresponds to a third matching circuit and the matching circuit 48 corresponds to a second matching circuit.

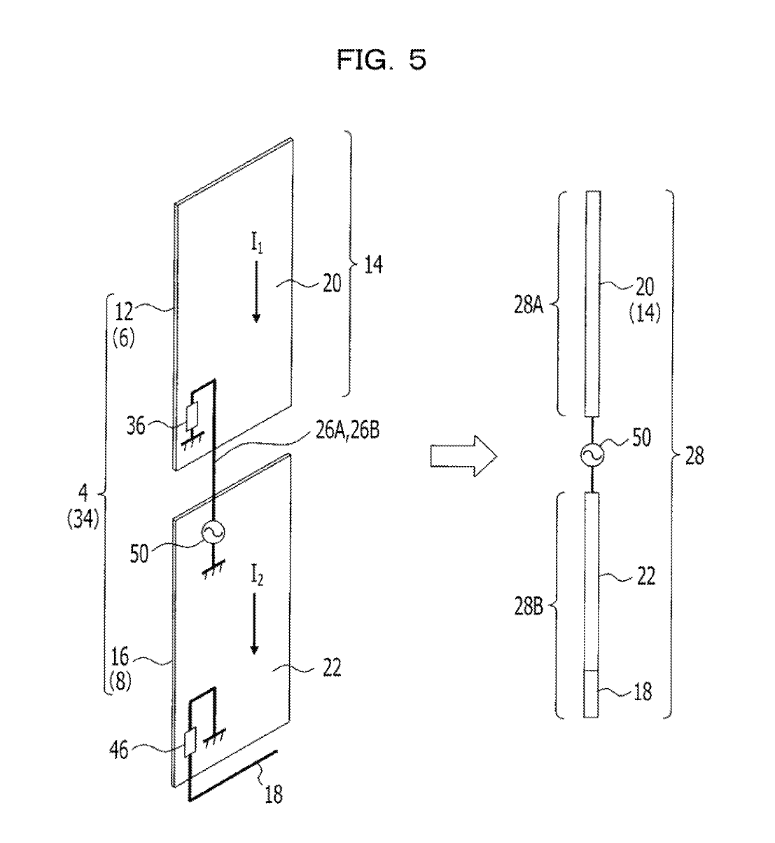

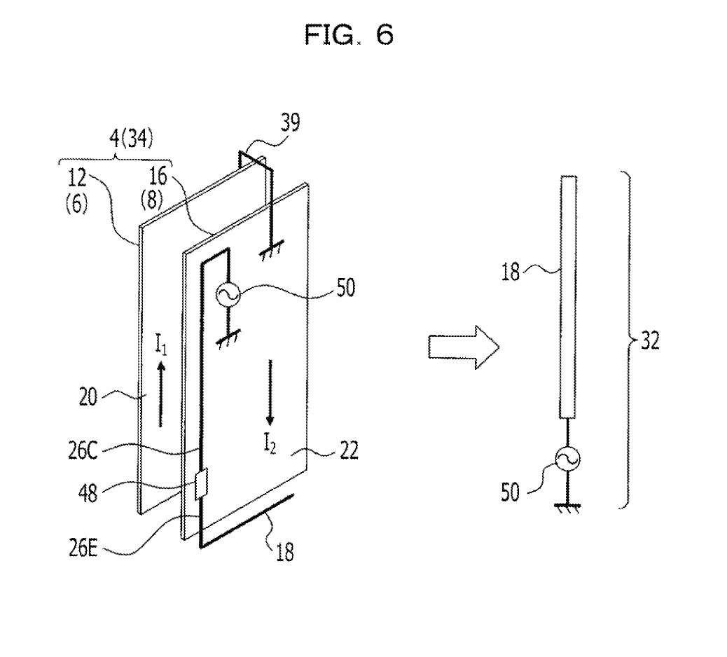

The ground conductor 20 on the circuit board 12 serves as a first antenna element 14 and the antenna element 18 serves as a monopole antenna 32. In other words, the cell phone 34 includes two antenna elements, one is a dipole antenna 28 (FIG. 5), and the other is the monopole antenna 32 (FIG. 6).

The ground conductor 22 is an example conductor part. The antenna element 18 is placed on the exterior of the circuit board 16 and is provided as an elongation element of the ground conductor 22 when the antenna element 18 serves as the dipole antenna 28 (FIG. 5).

A flexible substrate 39 is an example connection module, which is wired around the hinge 10 and connected to the connectors 38 and 40 as illustrated in FIG. 4. A power supply line 26A is arranged along the flexible substrate 39.

The ground conductor 20 is connected to the wireless unit 50 through the matching circuit 36, the power supply line 26A, the changeover switch 42, and the power supply line 26B. The changeover switch 42 is a device for switching between the connection of the power supply line 26A to the wireless unit 50 and the connection of the power supply line 26C to the wireless unit 50. The matching circuit 36 is an example device for matching the wireless unit 50 to the ground conductor 20 through the power supply line 26A, the changeover switch 42, and the power supply line 26B.

The wireless unit 50 is connected to the antenna element 18 through the matching circuit 46, a power supply line 26D, a changeover switch 44, and a power supply line 26E. The matching circuit 46 is an example of a device for matching the antenna element 18 and the ground conductor 22 to the wireless unit 50. The changeover switch 44 is an example device for switching between the connection of the antenna element 18 to the power supply line 26C and the connection of the antenna element 18 to the power supply line 26D.

Furthermore, the antenna element 18 is connected to the wireless unit 50 through the power supply line 26B, the changeover switch 42, the power supply line 26C, the matching circuit 48, the changeover switch 44, and the power supply line 26E. The matching circuit 48 is an example device for matching the antenna element 18 to the wireless unit 50 through the power supply line 26B, the changeover switches 42 and 44, and the power supply lines 26C and 26E.

Furthermore, the open/close sensor 52 is an example device for detecting opening and closing of the housing 4 and sends a detection signal as a result of the detection to a CPU 54. The CPU 54 is an example device for controlling switching between the changeover switches 42 and 44. Thus, the changeover switches 42 and 44 are connected to the CPU 54 through the control line 56.

The opening and closing of the housing 4 and the switching between the antennas will be described with reference to FIG. 5 and FIG. 6. FIG. 5 is a diagram illustrating an example dipole antenna which is set up in a cell phone in an open state. FIG. 6 is a diagram illustrating an example monopole antenna which is set up in a cell phone in an open state. In FIG. 5 and FIG. 6, the same reference numerals denote substantially the same structural components as those illustrated in FIG. 3.

When the cell phone 34 is in the open state, a dipole antenna 28 (FIG. 5) is formed. As illustrated in FIG. 5, the ground conductor 20 of the circuit board 12 on the housing 6 is connected to the wireless unit 50 through the matching circuit 36 and the power supply lines 26A and 26B. In addition, the ground conductor 22 for the antenna element 18, the matching circuit 46, and the circuit board 16 is connected to the wireless unit 50. In other words, the dipole antenna 28 illustrated in FIG. 5 is formed such that the ground conductor 20 is used for one antenna element part 28A of the dipole antenna 28, and both the ground conductor 22 and the antenna element 18 are used for the other antenna element part 28B.

In this dipole antenna 28, if I₁ denotes an emission current flowing through the ground conductor 20 and I₂ denotes an emission current flowing through the ground conductor 22, the emission currents I₁ and I₂ are in phase with each other.

In addition, when the cell phone 24 is in the closed state, a monopole antenna 32 (FIG. 6) is formed. As illustrated in FIG. 6, the antenna element 18 is connected to the wireless unit 50 through the power supply lines 26C and 26E to form a monopole antenna 32.

Since the ground conductors 20 and 22 face each other, the emission current I₁ flowing through the ground conductor 20 and the emission current I₂ flowing through the ground conductor 22 are in opposite phase to cancel each other out. As a result, the antenna element 18 serves as a monopole antenna 32.

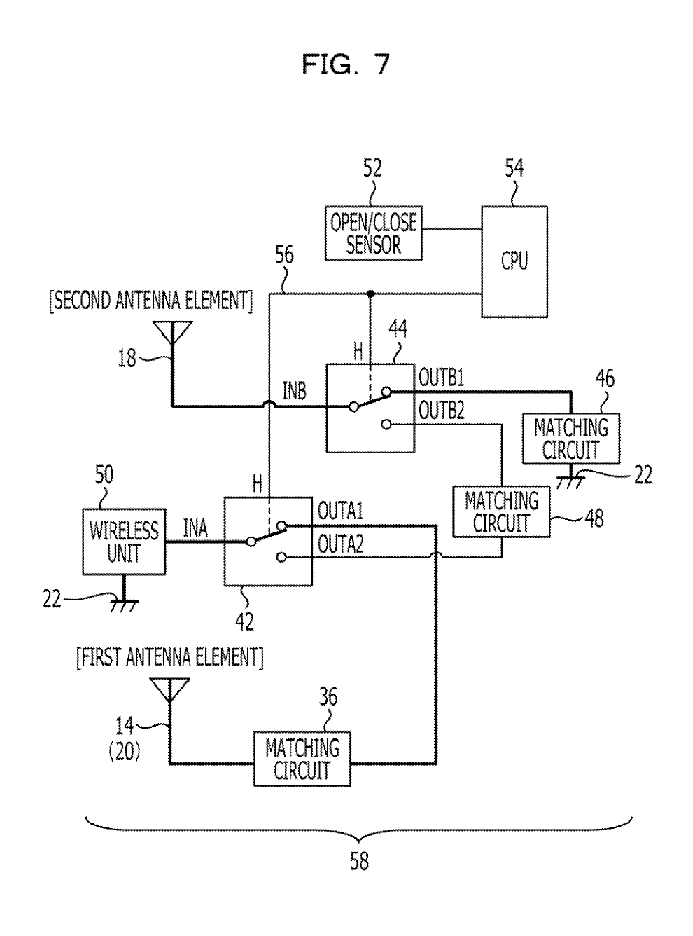

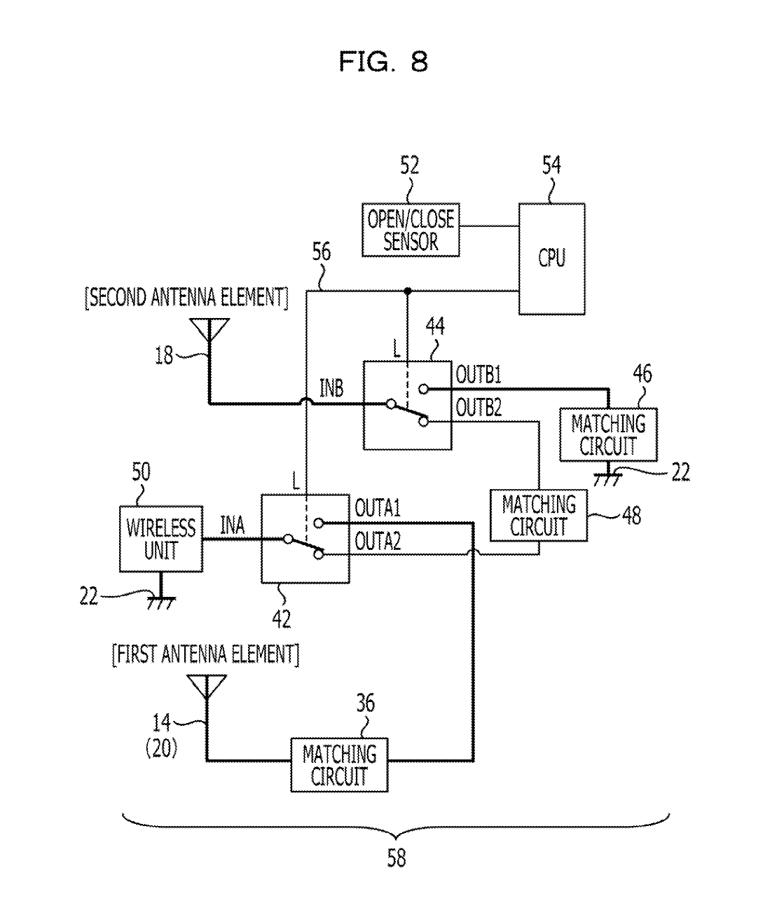

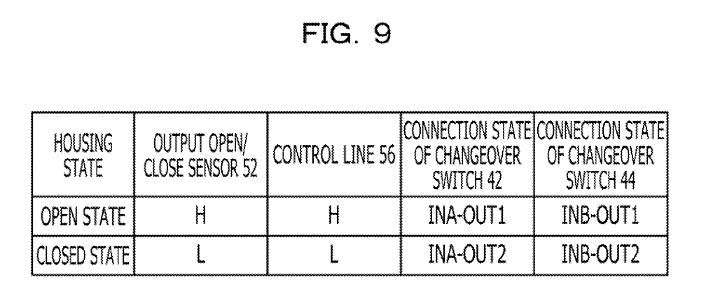

Referring now to FIGS. 7, 8, and 9, an antenna switching circuit will be described. FIG. 7 is a diagram illustrating the antenna-switching circuit when the housing is in an open state. FIG. 8 is a diagram illustrating the antenna-switching circuit when the housing is in a closed state. FIG. 9 is a diagram illustrating a control logic table of a changeover switch.

In an antenna-switching circuit 58, when the open/close sensor 52 detects the open state of the housing 4, the CPU 54 generates an output, for example a control output H, for setting up the dipole antenna 28. As illustrated in FIG. 7, the control output H makes the changeover switch 42 switch to OUTA1, while making the changeover switch 44 switch to OUTB1.

At this time, the wireless unit 50 is connected to the first antenna element 14 through the changeover switch 42 and the matching circuit 36, and also connected to the second antenna 18, the changeover switch 44, the matching circuit 46, and the ground conductor 22. Therefore, the dipole antenna 28 described above is formed and connected to the wireless unit 50.

When the open/close sensor 52 detects the closed state of the housing 4, the CPU 54 generates an output, for example a control output L, for setting up the monopole antenna 32. As illustrated in FIG. 8, the control output L makes the changeover switch 42 switch to OUTA2, while making the changeover switch 44 switch to OUTB2.

At this time, the wireless unit 50 is connected to the second antenna element 18 through the changeover switch 44, the matching circuit 48, and the changeover switch 42. Therefore, the monopole antenna 32 described above is formed and connected to the wireless unit 50.

As illustrated in FIG. 9, the switching between the antennas as described above employs control logic for the changeover switches 42 and 44.

According to the control logic, when the housing 4 is in the open state, the output of the open/close sensor 52 is high (H) and the aforementioned control output H is output to the control line 56. Thus, the connection state of the changeover switch 42 is switched to INA-OUTA1 and the connection state of the changeover switch 44 is switched to INB-OUTB1. Furthermore, when the housing 4 is in the closed state, the output of the open/close sensor 52 is low (L) and the aforementioned control output L is output to the control line 56. Thus, the connection state of the changeover switch 42 is switched to INA-OUTA2 and the connection state of the changeover switch 44 is switched to INB-OUTB2.

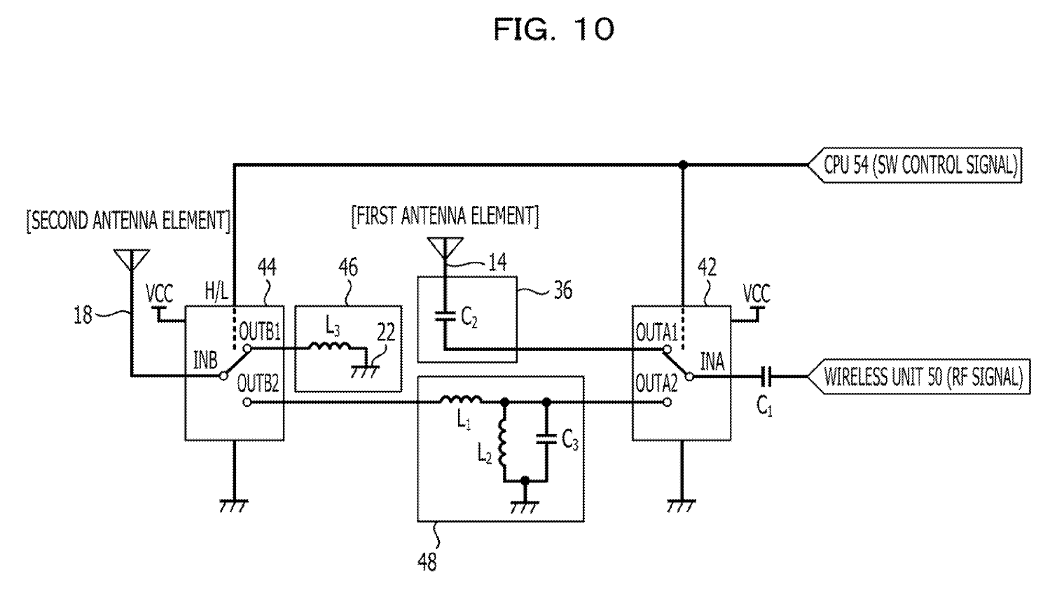

Referring now to FIG. 10, an antenna switching circuit will be described. FIG. 10 illustrates an example antenna switching circuit. In FIG. 10, the same reference numerals denote substantially the same structural components as those illustrated in FIGS. 7 and 8.

The wireless unit 50 is connected to the changeover switch 42 through a coupling capacitor C₁. The matching circuit 36, which is connected between the changeover switch 42 and the first antenna element 14, includes a capacitor C₂. In addition, the matching circuit 48 includes an inductor L₁, which is connected between the changeover switch 42 and the changeover switch 44 in series, and an inductor L₂ and a capacitor C₃, which are connected in parallel with each other. In addition, the matching circuit 46 includes an inductor L₃ connected between the changeover switch 44 and the ground controller 22.

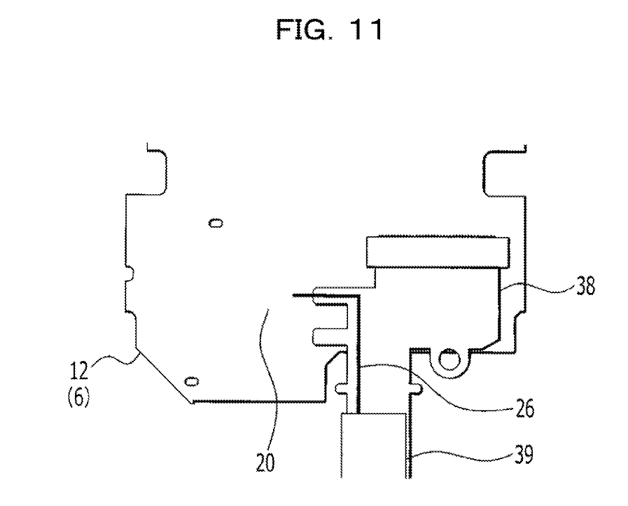

Referring now to FIGS. 11 to 14, the connection structure of the flexible substrate 39 arranged on the hinge unit 10 will be described. FIGS. 11 to 14 illustrate an example connection structure of the flexible substrate.

As illustrated in FIG. 11, the connector 38 is arranged on the circuit board 12 on the housing part 6 and connected to the flexible substrate 39. The power supply line 26 is connected to the ground conductor 20 of the circuit board 12 and placed on the flexible substrate 39.

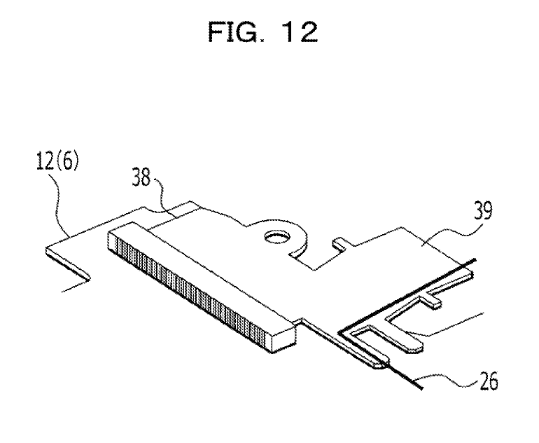

For example, the connector 38 connected to the flexible substrate 39 may be a FPC connector. As illustrated in FIG. 12, the connector 38 is fixed on the circuit board 12 and connected to the circuit wiring of the circuit board 12. The power supply line 26 is led to the housing part 8 through another route different from the route of the flexible substrate 39 and connected to the changeover switch 42.

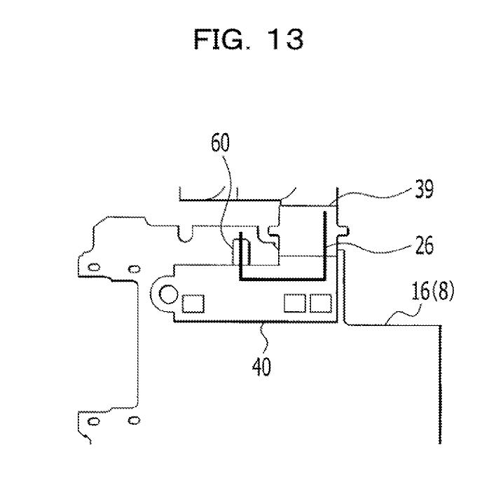

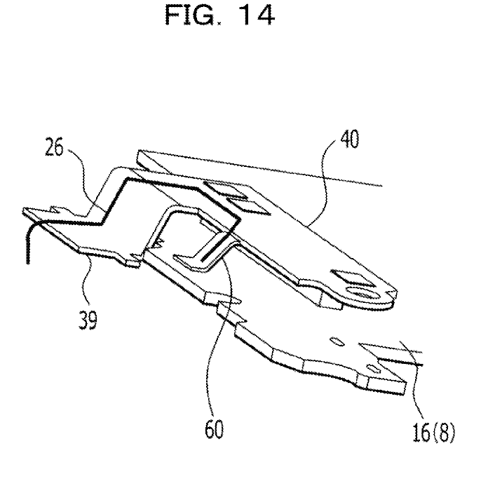

As illustrated in FIGS. 13 and 14, the flexible substrate 39 passing through the hinge 10 is led to the circuit board 16 on the housing part 8 and connected to the circuit wiring of the circuit board 16. The power supply line 26 passes through the hinge 10 along the flexible substrate 39 and is led to the circuit substrate 16.

The flexible substrate 39 is connected to the circuit board 16 using the connector 40, such as a stacking connector. The power supply line 26 is connected to the changeover switch 42 on the wireless unit 50 via a connection terminal section 60 provided on the stacking connector.

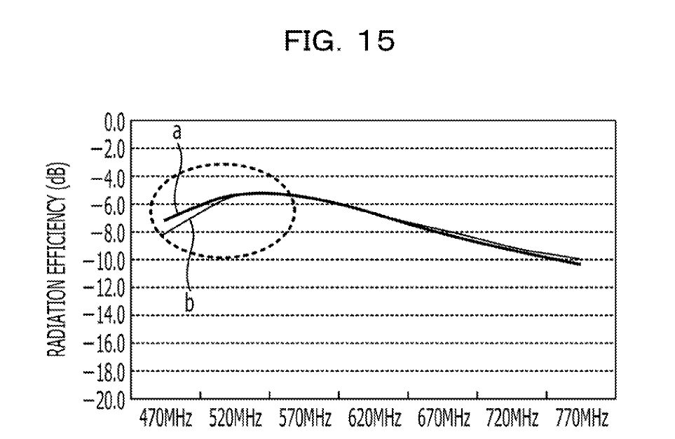

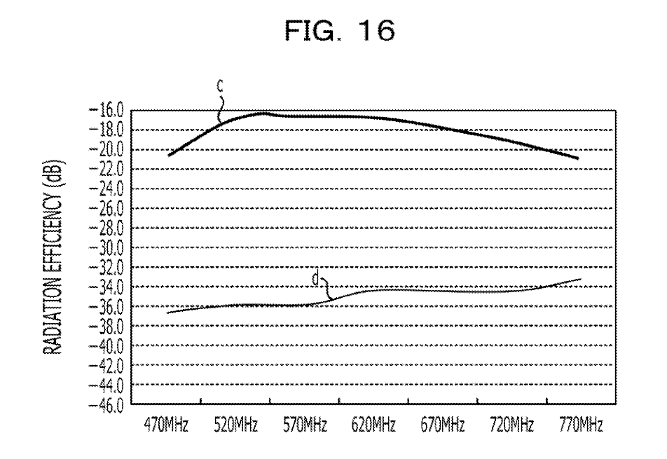

The characteristics of the dipole antenna 28 and the monopole antenna 32 will be described with reference to FIGS. 15 and 16. FIG. 15 illustrates the characteristics of the dipole antenna. FIG. 16 illustrates the characteristics of the monopole antenna.

FIG. 15 illustrates the antenna radiation characteristics of the dipole antenna 28. Thick line “a” represents the characteristics with the connected antenna element 18 present and thin line “b” represents the characteristics with the antenna element 18 absent.

As is evident from the comparison between the characteristics represented by the lines “a” and “b”, the dipole antenna 28 connected to the antenna element 18 serves as an elongation element of the ground conductor 22, so that the antenna radiation characteristics at a low frequency band may be improved.

FIG. 16 illustrates the antenna radiation characteristics of the monopole antenna 32. Thick line “c” represents the characteristics of the antenna element 18. Thin line “d” represents the characteristics of the antenna element 14 when the housing 4 is closed.

In the case where the housing 4 is closed, the first antenna element 14 has a low antenna radiation efficiency and little practicability. In contrast, the second antenna 18 has a high antenna radiation efficiency which is improved by about 20 [dB] even when the housing 4 is closed.

The above embodiment may reduce or prevent the antenna characteristics from being affected by the housing length due to a reduction of size and thickness of the housing and lowered usable frequency band.

When the housing 4 is opened, the housing 6 sets up the dipole antenna 28 from the ground conductor (conductor part) 22 and the antenna element 18 on the housing part 8 to make the dipole antenna 28 function as a first antenna element 14. In addition, the second antenna element 18 on the housing part 8 serves as a monopole antenna 32 when the housing 4 is closed.

When the housing 4 is opened, the second antenna element 18 is connected to the ground conductor 22 and operates as a GND elongation element. As a result, even if the housing part 8 or the housing 4 is shortened, the housing length may be made appear to be longer with respect to the wireless unit 50 (i.e., the power supply point 24). Thus, degradation of the antenna characteristics may be reduced or prevented due to the influence of the housing length.

The first antenna element 14, the second antenna element 18, the matching circuits 36, 46, and 48, the ground conductor 22, and the wireless unit 50 are connected to one another through the changeover switches 42 and 44. The CPU 54 determines the open or closed state of the housing 4 through the open/close sensor 52. The dipole antenna 28 or the monopole antenna 32 is automatically selected as a desired antenna in response to a control signal from the CPU 54. Thus, desired antenna characteristics may be obtained.

The wireless unit 50 supplies electric power to the first antenna 14 when the housing 4 is opened. The matching circuit 36 may be adjusted so that the resonance point of the first antenna element 14 may correspond to the usable frequency band. The second antenna element 18 is grounded through the matching circuit 46 and operates as a GND elongation element. The matching circuit 46 is adjusted using a constant which may be most effective for the second antenna element 18 operated as a GND ground at the usable frequency band.

The wireless unit 50 supplies electric power to the second antenna element 18 when the housing 4 is closed. In this case, the matching circuit 48 is adjusted so that the resonance point of the second antenna element 18 may correspond to the usable frequency band.

When the housing 4 is opened, the CPU 54 determines that the detection output of the open/close sensor 52 represents the open state, and then controls the changeover switches 42 and 44. The wireless unit 50 is connected to the first antenna element 14 through the matching circuit 36 and to the ground conductor 22 and the second antenna element 18 through the matching circuit 46.

When the housing 4 is closed, the CPU 54 determines that the detection output of the open/close sensor 52 represents the closed state, and then controls the changeover switches 42 and 44. At this time, the wireless unit 50 is connected to the second antenna element 18.

In this embodiment, the matching circuit 46 is constructed of a parallel L, the matching circuit 48 is constructed of a serial L and an LC parallel circuit. Here, L represents an inductance and C represents a capacitance.

The power supply line 26 is integrally formed with the signal line of the flexible substrate 39 passing through the hinge 10. The protruding portions of the flexible substrate 39 are connected to the respective circuit boards 12 and 16. That is, the strong connection structure contributes to the antenna characteristics.

When the cell phone 34 is opened, the influence of the housing length on the antenna characteristics may be reduced or prevented by the housing length due to a reduction of size and thickness of the housing and lower usable frequency band.

The antenna is switched to the second antenna element 18 and the antenna radiation efficiency is improved about 20 [dB] as illustrated in FIG. 16 when the cell phone 34 is closed.

As described above, the dipole antenna provided with the antenna element on the second housing is formed when the housing is in the open state and the monopole antenna is formed using the antenna element on the second housing. Thus, degradation of the antenna characteristics may be reduced or prevented.

When the housing is opened, the second antenna element is connected to the conductor part of the second housing to extend the antenna length. Thus, degradation of the antenna characteristics may be reduced or prevented.

Since the monopole antenna is constructed of the antenna element on the second housing part, degradation of the antenna characteristics may be reduced or prevented.

### Third Embodiment

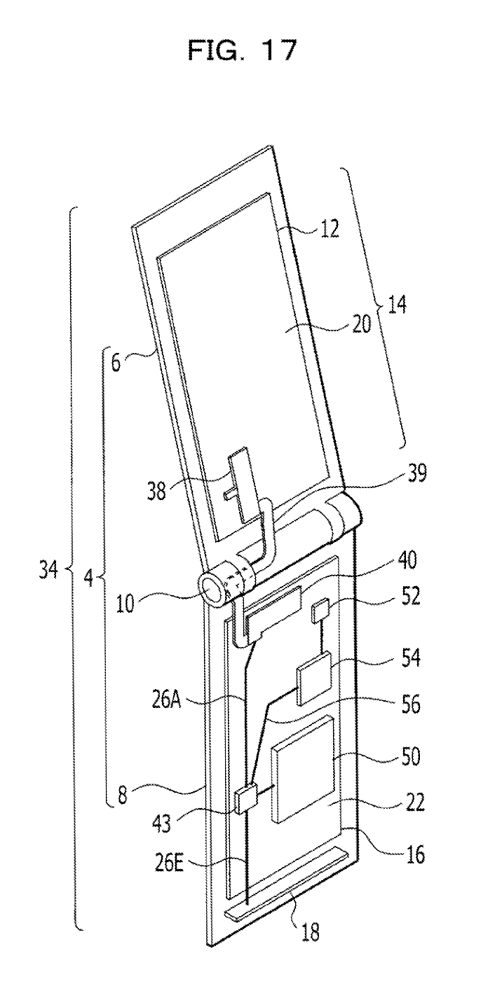

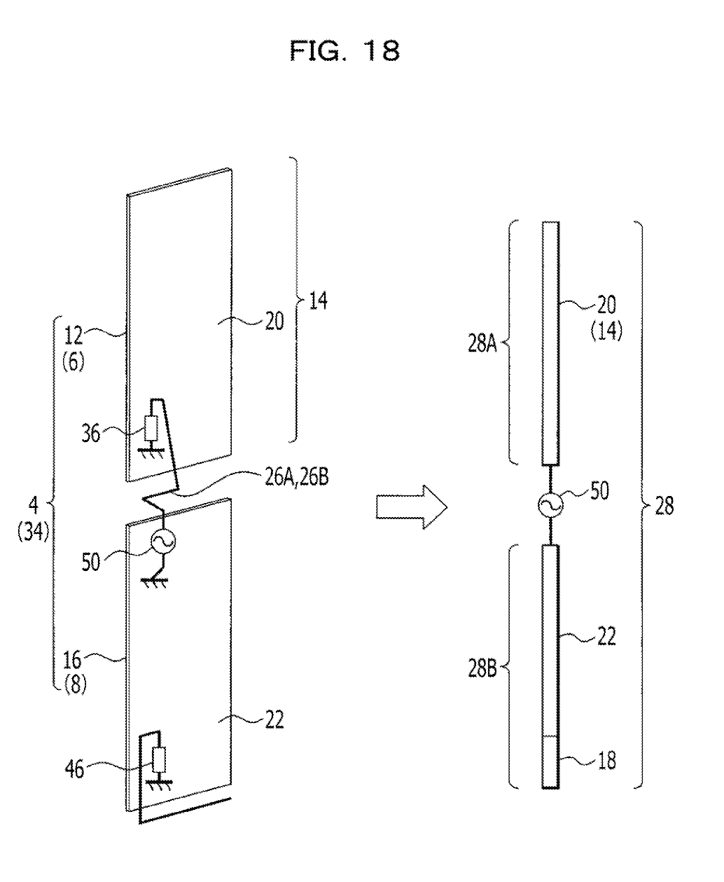

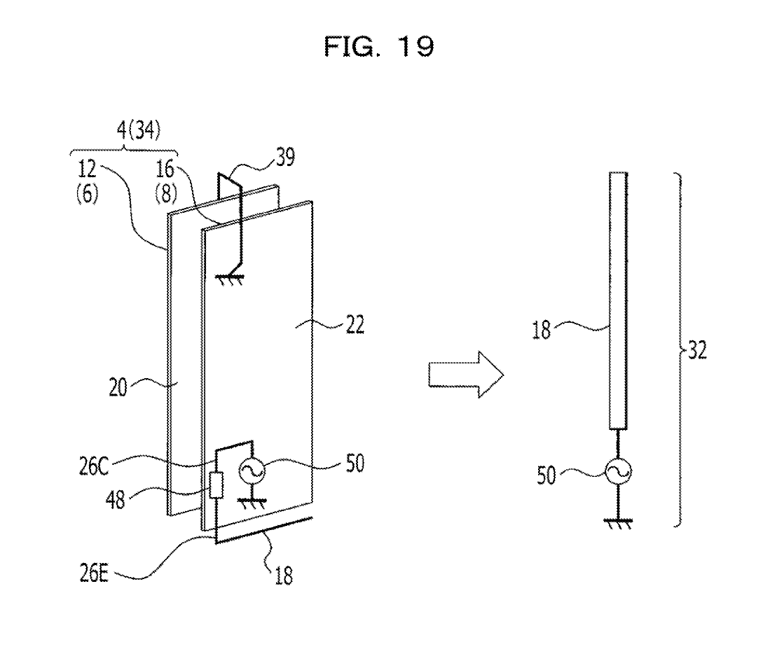

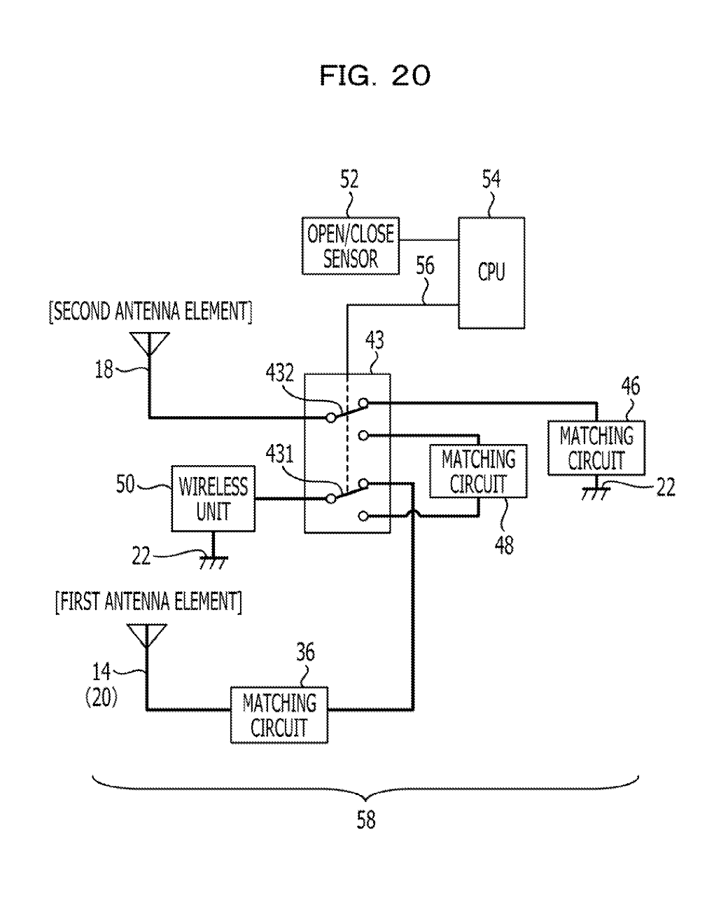

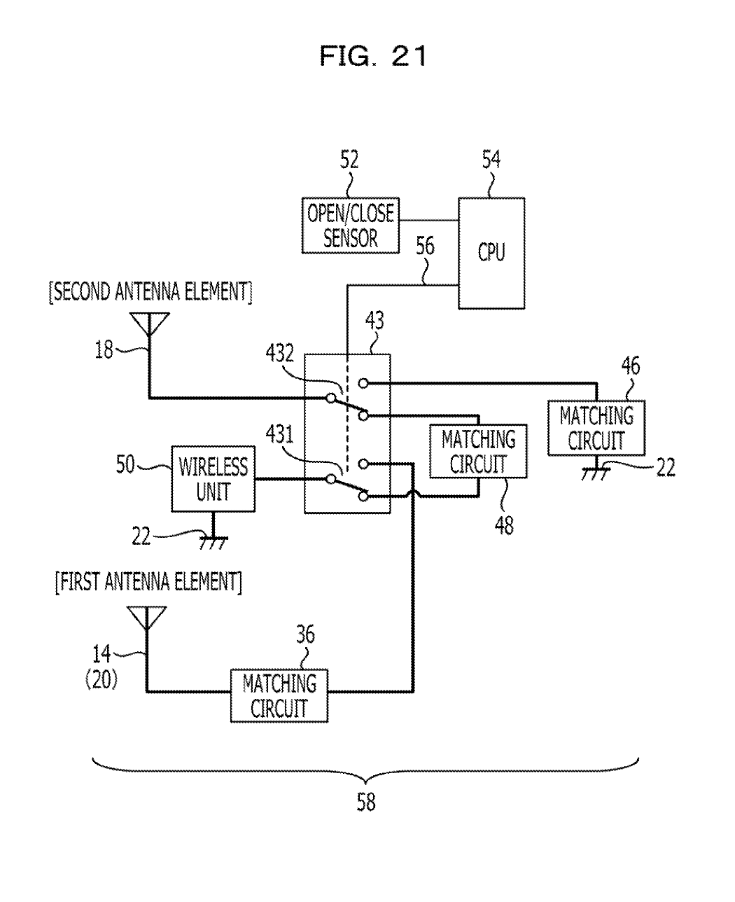

According to a third embodiment, a portable apparatus is designed so that a power supply unit is simplified and changeover switches are unified. The third embodiment will be described with reference to FIGS. 17 to 21. FIG. 17 is a diagram illustrating an example configuration of an antenna when a cell phone according to the third embodiment is in an open state. FIG. 18 is a diagram illustrating an example configuration of a dipole antenna. FIG. 19 is a diagram illustrating an example configuration of a monopole antenna. FIG. 20 is a diagram illustrating an example antenna-switching circuit when the cell phone is in the open state. FIG. 21 is a diagram illustrating an example antenna-switching circuit when the cell phone is in a closed state. In FIGS. 17 to 21, the same reference numerals denote substantially the same structural components as those illustrated in FIGS. 3, 7, and 8.

As illustrated in FIG. 17, the cell phone 34 of this embodiment uses wiring in the flexible substrate 39 as a part of a power supply line 26A. In addition, the aforementioned changeover switches 42 and 44 are unified as a changeover switch 43. In this embodiment, matching circuits 36, 46, and 48 are simplified in these figures. Since other structural components are substantially the same as those of the second embodiment, the same reference numerals will be provided and their descriptions will be omitted.

Even in this configuration, a dipole antenna 28 is set up when a housing 4 is opened as illustrated in FIG. 18 and FIG. 20 and a monopole antenna 32 is set up when the housing is closed as shown in FIG. 19 and FIG. 21.

When an open/close sensor 52 detects the open state of the housing 4, a wireless unit 50 is connected to a first antenna element 14 through a contact point 431 of the changeover switch 43 and a matching circuit 36, and also connected to a second antenna element 18 through a contact point 432 of the changeover switch 43, a matching circuit 46, and a ground conductor 22. Therefore, the dipole antenna 28 described above is formed and connected to the wireless unit 50.

When the open/close sensor 52 detects the closed state of the housing 4, the wireless unit 50 is connected to the second antenna element 18 through the contact point 432 of the changeover switch 43, the matching circuit 48, and the contact point 431 of the changeover switch 42. Therefore, the monopole antenna 32 described above is formed and connected to the wireless unit 50.

### Fourth Embodiment

According to a fourth embodiment, a portable apparatus has the configuration of a television (TV) receiver circuit.

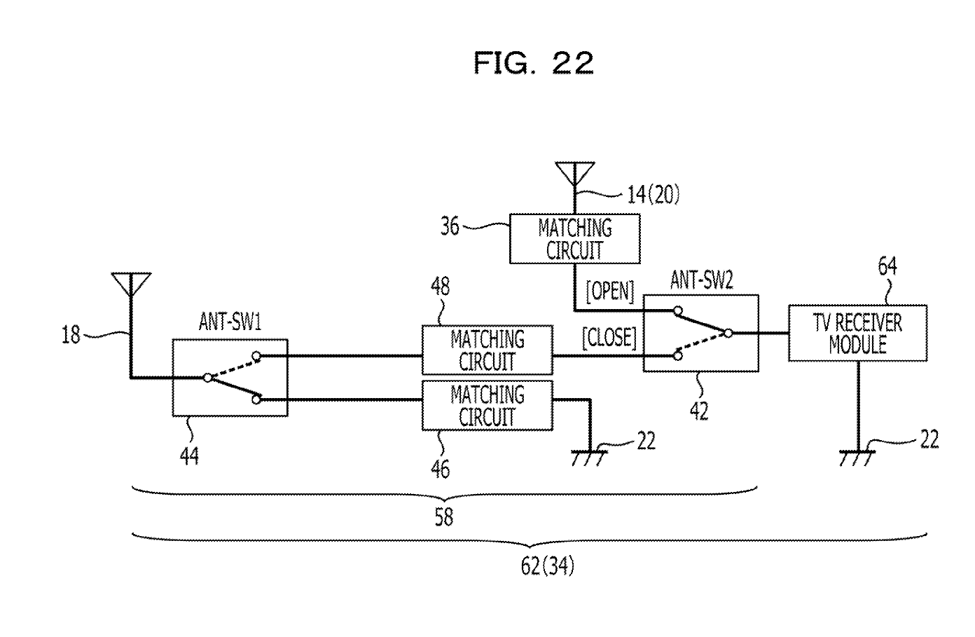

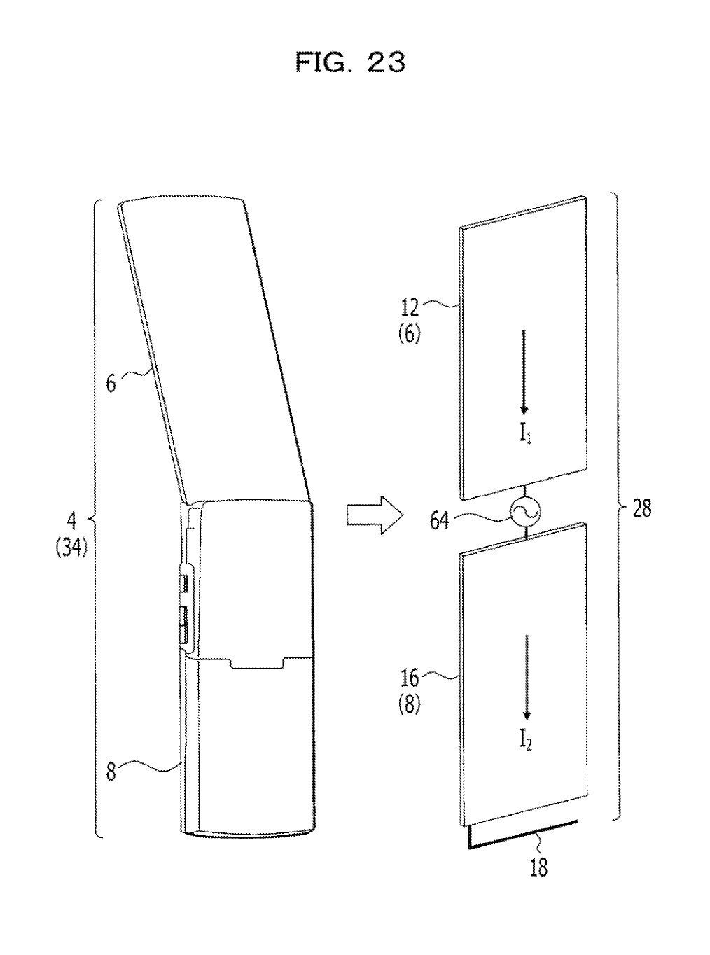

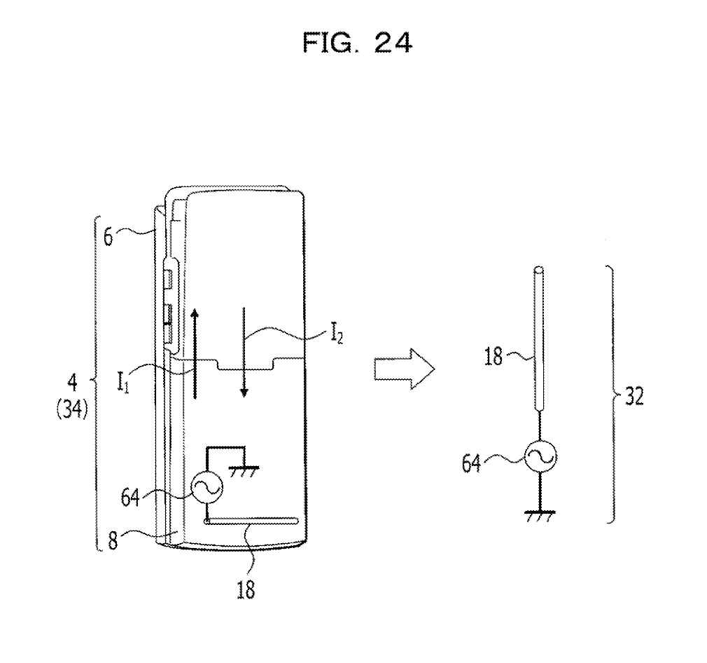

The fourth embodiment will be described with reference to FIGS. 22 to 24. FIG. 22 is a figure showing a TV receiver circuit example configuration according to the fourth embodiment. FIG. 23 is a diagram illustrating an example configuration of a dipole antenna which is set up when a cell phone is in an open state. FIG. 24 is a diagram illustrating an example configuration of a monopole antenna which is set up when the cell phone is in a closed state. In each of FIG. 23 and FIG. 24, the same reference numerals denote substantially the same structural components as those illustrated in FIG. 3.

The TV receiver circuit 62 of this embodiment includes a TV receiver module 64 which is connected to the aforementioned antenna-switching circuit 58. The TV receiver module 64 includes a high-frequency amplifying circuit, a tuning circuit, a demodulating circuit, and so on and is configured to be able to reproduce pictures and sounds of TV broadcasts.

In this configuration, changeover switches 42 and 44 respectively become the states illustrated in the figure when the housing 4 of a cell phone 34 is in an open state. In this case, the TV receiver module 64 is connected to a dipole antenna 28 which is constructed of an antenna element 14, a ground conductor 22, and an antenna element 18. This dipole antenna 28 receives TV broadcasts.

Furthermore, the changeover switches 42 and 44 are in the states represented by dashed lines, respectively, when the housing 4 is in a closed state. In this case, the TV receiver module 64 is connected to the antenna element 18 through a matching circuit 48 and the changeover switches 42 and 44. In other words, the TV receiver module 64 is connected to the monopole antenna 32, so that TV broadcasts may be received through the monopole antenna 43.

The TV receiver module 64 may receive TV broadcasts through either of the antennas 28 and 32. In the case where the housing 4 is in the open state, the antenna element 18 is provided as a part of the dipole antenna 28 and serves as an elongation element of a ground conductor 22 of the antenna element 18. Therefore, improvements in radiation characteristics and TV receiver sensitivity of the antenna may be attained. In this case, as illustrated in FIG. 23, emission current I₁ flows through the housing part 6 of the dipole antenna 28 and emission current I₂ flows through the housing part 8 of the dipole antenna 28 when the housing 4 of the cell phone 34 is opened. Therefore, since the emission currents I₁ and I₂ are in phase with each other and the antenna element 18 serves as an elongation element, the radiation characteristics of the antenna may be enhanced.

When the housing 4 is closed, as illustrated in FIG. 24, the emission currents I₁ and I₂ flowing through the housing parts 6 and 8 are in opposite phase and cancel each other out. The antenna element 18 is connected as a monopole antenna 32 to the TV receiver module 64 and receives the supply of electric power. As a result, even if the housing 4 is closed, TV broadcasts may be received by the monopole antenna 32 with similar quality as the dipole antenna 28.

In this embodiment and the aforementioned embodiments, the maximum radiation efficiency may be obtained by adjusting the length of the antenna element 18 and performing matching adjustment of matching circuits 36, 46, and 48.

According to the above configuration, the addition of the antenna element 18 may result in desired antenna radiation efficiency for receiving broadcasts, such as TV broadcasts, irrespective of the opening or closing of the housing 4. Therefore, broadcast reception characteristics may be improved.

### Other Embodiments

In the aforementioned embodiments, the portable apparatus 2 and the cell phone 34 have been described for illustrative purposes, but are not limited thereto. For example, the aforementioned embodiments may be applied to a personal digital assistant (PDA), a personal computer, or a TV receiver, which are capable of receiving broadcasts.

Radiation efficiency has been described for the purpose of describing the antenna characteristics. Likewise, the dipole antenna and the monopole antenna of the present disclosure have increased antenna gains because each of them is provided with the antenna element 18.

### Comparative Example

The antenna characteristics of an openable/closable portable apparatus as a comparative example will be described.

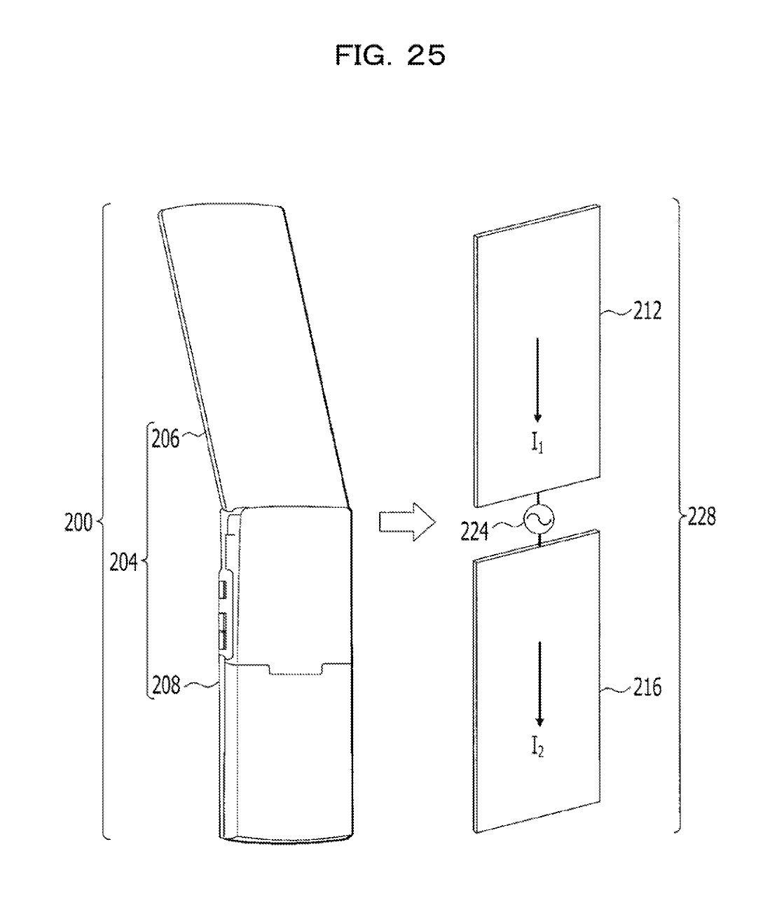

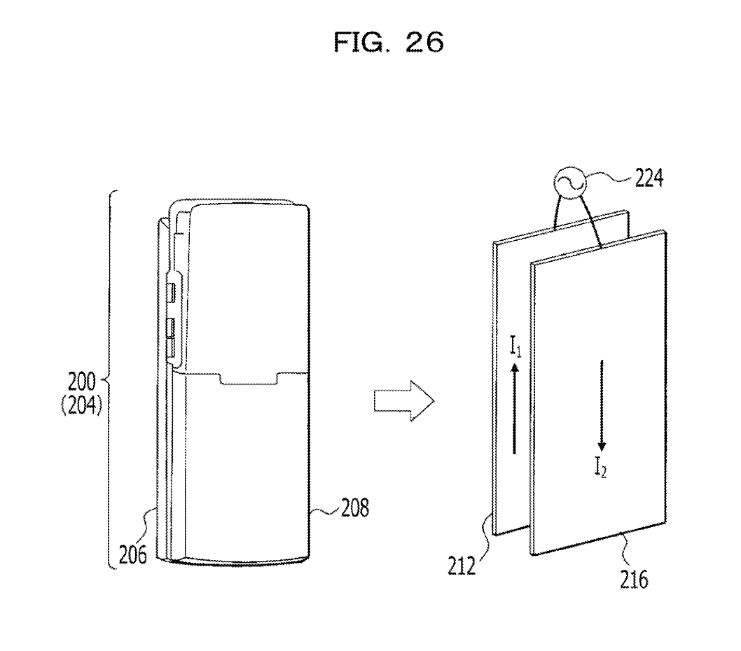

FIG. 25 and FIG. 26 are referred to for the comparative example. FIG. 25 illustrates a dipole antenna which is set up in a cell phone in an open state. FIG. 26 illustrates an antenna which is set up in a cell phone in a closed state.

The cell phone 200 of the comparative example includes housing parts 206 and 208 as an openable/closable housing 204.

When the housing 204 is opened, as illustrated in FIG. 25, the housing parts 206 and 208 serve as antenna elements, respectively, and a power supply point 224 is provided in a dipole antenna 228. The dipole antenna 228 includes a circuit board 212 on the housing part 206 and a circuit board 216 on the housing part 208, which serve as antenna elements, respectively. In other words, emission currents I₁ and I₂ in phase flow through the circuit boards 212 and 216, which serve as antenna elements, respectively. In this dipole antenna 228, the length of the housing is short with respect to usable wavelengths when the cell phone 200 is reduced in size or a usable frequency band is lowered. As a result, a decrease in antenna performance may occur.

However, as illustrated in FIG. 26, when the housing 204 is closed, the emission current I₁ flowing through the circuit board 212 and the emission current I₂ flowing through the circuit board 216 become out of phase with each other, so that they may have difficulty functioning as antennas or a decrease in antenna characteristics may occur.

In this cell phone 200, if the housing 204 is downsized and the length thereof is shortened, a sufficient antenna length may not be obtained easily. If an extension board is placed on the housing part 206 or the housing part 208 and connected to the circuit board via a connection member to obtain a sufficient antenna length, an additional space may be desired for the extension board. This configuration prevents the cell phone 200 from being reduced in size and thickness.

According to the aforementioned embodiments, the dipole antenna and the monopole antenna may realize excellent antenna characteristics without a reduction in size or impairing flatness of the housing. Furthermore, the dipole antenna and the monopole antenna may be switched from each other by opening or closing the housing. In the dipole antenna, the antenna element 18 is added to the ground conductor 22 to complement the length of the conductor, thereby reducing or preventing degradation of the antenna characteristics by a reduction in the size of the housing.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Although the embodiments of the present invention have been described in detail, it should be understood that the various changes, substitutions, and alterations could be made hereto without departing from the spirit and scope of the invention.

What is claimed is:

1. A wireless communication apparatus, comprising:
a first housing;
a second housing which is openably and closably connected to the first housing through a hinge;
a first conductor part which is arranged on the first housing;
a second conductor and an antenna element, which are arranged on the second housing; and
an antenna switching part that makes the first conductor part, the second conductor part, and the antenna element serve as a dipole antenna when the first housing and the second housing are in an open state, and makes the antenna element serve as a monopole antenna when the first housing and the second housing are in a closed state.

2. The wireless communication apparatus according to claim 1, further comprising:
an opening/closing detection unit to detect opening and closing of the first housing and the second housing; and
a control unit to control the antenna switching part in response to the detection by the opening/closing detection unit.

3. The wireless communication apparatus according to claim 1, further comprising:
a power supply unit;
a first matching circuit which is placed between the first conductor part and the power supply unit; and
a second matching circuit which is placed between the power supply unit and the antenna element.

4. The wireless communication apparatus according to claim 1, wherein
the antenna element is connected to the second conductor through the third matching circuit when the first housing and the second housing are opened.
